(19) United States
(12) Patent Application Publication
(10) Pub. No.: US 2007/0085458 A1
(43) Pub. Date: Apr. 19, 2007

(54) PDP filter and method of manufacturing the same

(75) Inventors: Dong Keun Sin, Hwaseong-si (KR); Dong Hyun Park, Gumi-si (KR); Ji Yoon Seo, Gumi-si (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SAMSUNG CORNING CO., LTD., Suwon-si (KR)

(21) Appl. No.: 11/580,972

(22) Filed: Oct. 13, 2006

(30) Foreign Application Priority Data
Oct. 14, 2005 (KR) 10-2005-0097145

(51) Int. Cl. H01J 61/40; H01J 5/16; H01K 1/26; H01K 1/30

(52) U.S. Cl. 313/112

(57) ABSTRACT

PDP filter and a method for manufacturing the same. The PDP filter comprises an electromagnetic shielding layer including an electromagnetic shielding pattern having a transparent substrate and a non-electroplating layer pattern formed on a surface of the transparent substrate, a color correction layer formed on the electromagnetic shielding pattern, and a filter base formed on another surface of the transparent substrate.

### CROSS-REFERENCE TO RELATED APPLICATION

This application claims the benefit of Korean Patent Application No. 10-2005-0097145, filed on Oct. 14, 2005, in the Korean Intellectual Property Office, the disclosure of which is incorporated herein by reference.

### BACKGROUND OF THE INVENTION

1. Field of the Invention

The present invention relates to a PDP filter and a method of manufacturing the same, and, more particularly, to a PDP filter and a method of manufacturing the same, which has an improved haze value.

2. Description of the Related Art

As modern society becomes more information-oriented, technology for photoelectronic devices and apparatuses is advancing, and these devices are becoming widespread. In particular, image display devices are in widespread use in devices such as TV screens and PC monitors. Thinly built wide screens have become mainstream display devices.

Generally, a plasma display panel (PDP) is gaining popularity as a next-generation display device to replace a cathode ray tube (CRT) because it is thin and has a large screen. A PDP device displays images based on a gas discharge phenomenon, and exhibits superior display characteristics, e.g., a high display capacity, high brightness and contrast, free from after-image, and a wide viewing angle. Also, the PDP device facilitates the display device's comparatively large size, and is regarded as a thin type light emitting display device having advantageous characteristics most suitable for high display quality digital television, such that the PDP device is widely used as a substitute for a CRT.

In a PDP device, when a direct current (DC) or alternating current (AC) voltage is applied to electrodes, a gas discharge occurs, which produces ultraviolet (UV) rays. The UV emission excites adjacent phosphors to emit visible light. Despite the above advantages, the PDPs have several problems associated with driving characteristics, including an increase in electromagnetic (EM) radiation. The EM radiation generated by the PDPs may adversely affect humans and cause electronic devices, e.g., wireless telephones, or remote controllers, to malfunction. Thus, in order to use such PDPs, there is a need to reduce the EM radiation emitted from the PDPs to a certain level or less, e.g., by shielding. For example, various PDP filters having an EM shielding function can be used with the PDPs.

A PDP device includes a panel assembly that has a discharge cell in which gas discharge occurs and a PDP filter that shields electromagnetic waves and near-infrared rays. The PDP filter, which is mounted on the entire surface of the panel assembly, should have satisfactory transparency.

In the PDP device, an electric current flowing between a driving circuit and an alternating current (AC) electrode, and a high voltage between electrodes used for plasma discharge are the main causes of electromagnetic waves. The electromagnetic waves generated by such causes are mainly in the frequency band of 30-200 MHz. Generally, a transparent conductive film or a conductive mesh that maintains a high light transmittance and a low refractive index in a visible light region is used as an electromagnetic shielding layer for shielding the generated electromagnetic waves.

An electromagnetic shielding layer made of a transparent conductive film such as an Indium Tin Oxide (ITO) film reduces electromagnetic shielding capability due to its low conductivity. Conversely, an electromagnetic shielding layer made of a conductive mesh exhibits a superior electromagnetic shielding capability. Accordingly, the electromagnetic shielding layer made of a conductive mesh is mainly used.

Hereinafter, a conventional method for manufacturing a PDP filter including a conductive mesh will be described with reference to FIGS. 1A to 1E. FIGS. 1A to 1E are cross-sectional views illustrating sequential processing steps for describing the conventional method of manufacturing a PDP filter.

As illustrated in FIG. 1A, a metal thin film 30 is attached to a transparent substrate 10 using an adhesive 20 having appropriate adhesion strength through lamination. The transparent substrate 10 is generally a polyethylene terephthalate (PET) film.

As illustrated in FIG. 1B, a photoresist pattern 40 is formed by coating a photoresist on the metal thin film 30 and patterning the photoresist using a photolithographic process (an exposure process and a development process).

As illustrated in FIG. IC, an electromagnetic shielding pattern 32 is formed by etching the metal thin film 30 using the photoresist pattern 40 as an etching mask.

As illustrated in FIG. ID, a filter base 75 coated with an adhesive 55 on one side is prepared. The filter base 75 includes a transparent substrate 50 that maintains a structure of the filter base 75, the adhesive 55 coated on one surface of the transparent substrate 50, a color correction film 60 formed on another surface of the transparent substrate 50, a near-infrared shielding film 65, and an antireflective film 70.

As illustrated in FIG. 1E, a PDP filter 80 is completed by attaching the adhesive 55 of the filter base 75 to the transparent substrate 10 provided with the electromagnetic shielding pattern 32.

However, the PDP filter manufactured by the aforementioned conventional method has limitations in improving haze characteristics. In particular, when the electromagnetic shielding film is formed, an attempt to improve the adhesive strength between the electromagnetic shielding film and the transparent substrate by forming an adhesive surface of the metal thin film to have a rough surface causes an increase in a haze value of the PDP filter due to diffused reflection of light.

### SUMMARY OF THE INVENTION

To solve the above described and/or other problems, the present invention provides a PDP filter having improved haze characteristics.

The present invention also provides a method for manufacturing the PDP filter.

Additional aspects and/or advantages of the invention will be set forth in part in the description which follows and, in part, will be apparent from the description, or may be learned by practice of the invention.

According to an aspect of the present invention, there is provided a PDP filter, the PDP filter includes an electromagnetic shielding layer including an electromagnetic shielding pattern having a transparent substrate and a non-electroplating layer pattern formed on a surface of the transparent substrate, a color correction layer formed on the electromagnetic shielding pattern, and a filter base formed on another surface of the transparent substrate.

According to another aspect of the present invention, there is provided a method of manufacturing a PDP filter, the method includes forming a non-electroplating layer on one surface of a transparent substrate, forming an electromagnetic shielding pattern by patterning the non-electroplating layer, adhering a filter base onto another surface of the transparent substrate, provisionally adhering a color correction layer onto the electromagnetic shielding pattern, and fixing the color correction layer onto the electromagnetic shielding pattern by performing an autoclave process.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A to 1E are cross-sectional views illustrating sequential processing steps for describing a conventional method of manufacturing a PDP filter;

FIG. 2 is a cross-sectional view illustrating a PDP filter according to an exemplary embodiment of the present invention; and

FIG. 3 to FIG. 9 are cross-sectional views illustrating sequential processing steps for describing a method of manufacturing a PDP filter according to an exemplary embodiment of the present invention.

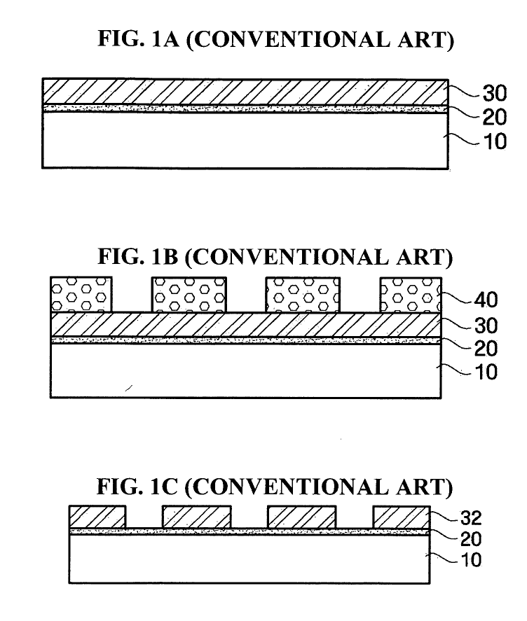

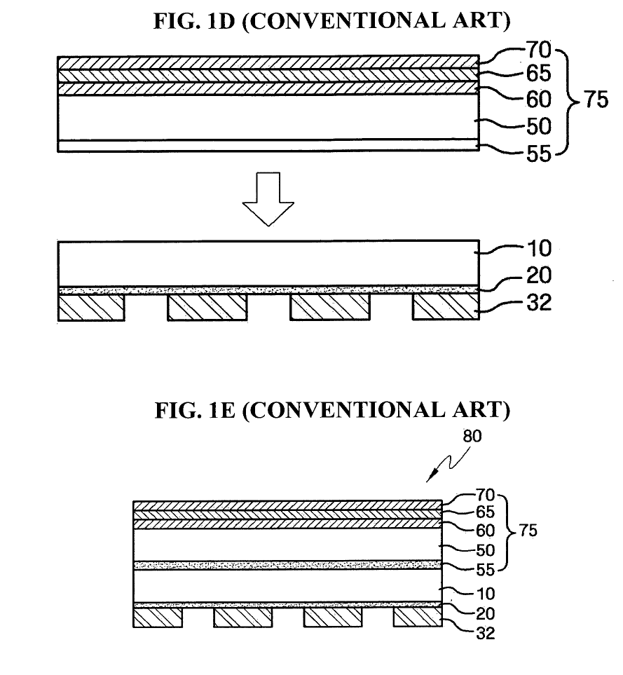

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

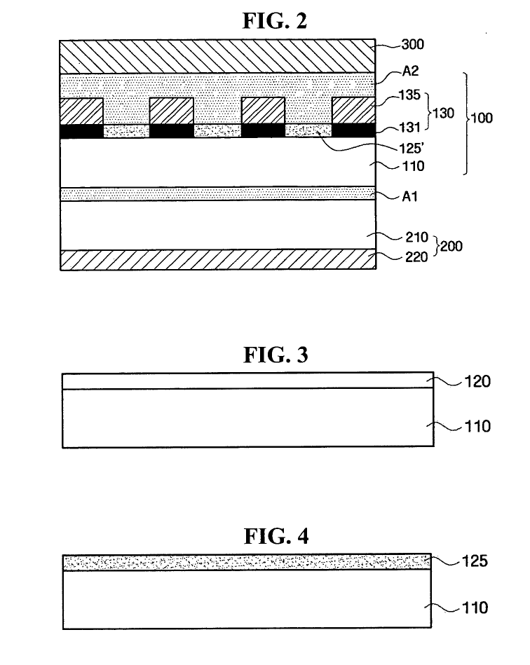

Hereinafter, a PDP filter according to an exemplary embodiment of the present invention will be described with reference to FIG. 2.

FIG. 2 is a cross-sectional view illustrating a PDP filter according to an exemplary embodiment of the present invention. Referring to FIG. 2, the PDP filter according to an exemplary embodiment of the present invention includes an electromagnetic shielding layer 100, a filter base 200, and a color correction layer 300.

The electromagnetic shielding layer 100 includes an electromagnetic shielding layer pattern 130 provided on one surface of a transparent substrate 110. The electromagnetic shielding layer pattern 130 includes a non-electroplating layer pattern 135. In this case, the electromagnetic shielding layer pattern 130 may further include a black layer pattern 131 at one side of the non-electroplating layer pattern 135, for example, below the non-electroplating layer pattern 135 adjacent to the transparent substrate 110. The black layer pattern 131 can be formed by being aligned at a sidewall of the non-electroplating layer pattern 135.

The non-electroplating layer pattern 135 is a metal layer formed by an non-electroplating method, and a conductive material that can shield electromagnetic waves can be used as the non-electroplating layer pattern 135. For example, every metal having excellent electric conductivity and workability, such as copper (Cu), chromium (Cr), nickel (Ni), silver (Ag), molybdenum (Mo), tungsten (W), and aluminum (Al), may be used as the non-electroplating layer pattern 135. Among the above metals, Cu and Ni are preferable in view of cost, electric conductivity, and workability. More preferably, Cu may be used as non-electroplating layer pattern 135. The non-electroplating layer may be formed on the transparent substrate without using an adhesive. Accordingly, since a rough surface is not required on one surface of such a metal thin film, unlike the conventional PDP filter where the rugged portion is conventionally required to improve adhesive strength between the metal thin film and the transparent substrate, haze characteristics can be improved.

Preferably, the electromagnetic shielding layer pattern 130 has a thickness of 0.5 μm to 40 μm. More preferably, the electromagnetic shielding layer pattern 130 has a thickness of 3 μm to 10 μm. When the electromagnetic shielding layer pattern 130 has a thickness less than about 0.5 μm, electromagnetic shielding capability may be reduced, and when the electromagnetic shielding layer pattern 130 has a thickness greater than about 40 μm, manufacturing time may increase. In order to absorb all the electromagnetic waves generated from the panel assembly, the conductive electromagnetic shielding layer pattern needs a thickness more than a predetermined value. However, since visible light transmittance is reduced as the conductive metal thin film thickness is increased, it is preferable to form the electromagnetic shielding layer pattern at a proper thickness considering the visible light transmittance characteristics.

A transparent material may be used as the transparent substrate 110 provided in the electromagnetic shielding layer 100 without any specific limitation. For example, an inorganic compound forming material such as glass and quartz and a transparent organic high polymer forming material may be used as the transparent substrate 110. More preferably, the organic high polymer forming material may be used due to its lightweight and rigid characteristics. The transparent substrate 110 may have a thickness in the range of 80 μm to 200 μm.

Although acryl or polycarbonate is generally used as the organic high polymer forming material, the present invention is not limited to such a material. It is preferable that the transparent substrate 110 has high transparency and heat-resistant characteristics. The high polymer forming material having a layered laminate may be used as the transparent substrate 110. It is preferable that the transparent substrate 110 has visible light transmittance in the range of 80% or greater with respect to transparency and has a glass transition temperature in the range of about 60° C. with respect to heat-resistant characteristics. It is sufficient that the high polymer forming material should be transparent in a visible wavelength area. Examples of the high polymer forming material include PET, polysulfone (PS), polyethersulfone (PES), polystyrene, polyethylene, naphthalate, polyarylate, polyetheretherketone (PEEK), polycarbonate (PC), polypropylene (PP), polyimide, triacetylcellulose (TAC), and polymethylmetacrylate (PMMA). However, the high polymer forming material is not limited to these examples. Among them, PET is preferably used in view of cost, heat-resistant characteristics, and transparency.

Also, the filter base 200 is formed on a surface of the electromagnetic shielding layer 100, specifically the other surface of the transparent substrate 110. The filter base 200 may further include a layer having an optical function, such as an antireflective layer 220, which is formed on a transparent substrate 210. An adhesive layer Al may be interposed between the electromagnetic shielding layer 100 and the filter base 200.

The transparent substrate 210 can be formed at a thickness of 2.0 mm to 3.5 mm by using a reinforcing or semi-reinforcing glass or a transparent plastic material such as acryl. Since such a glass has specific gravity of about 2.6, it is difficult to manufacture a lightweight filter. Also, since the glass is relatively thick, when the glass is set on a plasma display panel, the entire weight of the panel increases. However, the glass is excellent for preventing the plasma display panel from becoming broken.

A thin film, such as a fluoric based transparent high polymer resin, MgF, silicon based resin, or Sio₂, having a refractive index less than 1.5 in a visible area, preferably less than 1.4, may be used as the antireflective layer 220. In this case, the antireflective layer may be formed in a single layer by an optical thickness of ¼ of a wavelength. Alternatively, the antireflective layer may be formed in two or more layers having different refractive indexes of either inorganic compound such as metal oxide, fluoride, silicide, boride, carbide, nitride, and sulfide, or organic compound such as silicon based resin, acryl resin, and fluorine based resin.

The antireflective layer 220 may be formed on the other surface of the transparent substrate 210 after adhering one surface of the transparent substrate 210 to the electromagnetic shielding layer 100.

For example, in an exemplary embodiment of the present invention, the antireflective layer 220 may have a structure obtained by alternately layering an oxide film of a low refractive index, such as SiO₂, and an oxide film of a high refractive index, such as TiO₂ or Nb₂O₅. These oxide films can be formed by sputtering or wet coating. The antireflective layer 220 has a thickness of 20 nm to 300 nm

Also, the color correction layer 300 is provided on the other surface of the electromagnetic shielding layer 100, specifically on the electromagnetic shielding layer pattern 130. The color correction layer 300 can be adhered to the electromagnetic shielding layer 100 by using an adhesive layer A2. As illustrated in FIG. 9, the adhesive layer A2 can be formed to fill an empty space of the electromagnetic shielding layer pattern 130. Although the color correction layer 130 may be a hybrid film having a neon light shielding function and a near-infrared shielding function, a neon light shielding layer and a near-infrared shielding layer may separately be formed. The color correction layer 300 has a thickness in the range of 5 μm to 150 μm.

In the case where a neon light shielding layer and a near-infrared shielding layer are separately provided to constitute the color correction layer 300, since the neon light shielding layer serves to correct Range to red, it is more preferable that visible light generated from plasma inside the panel assembly undergoes color correction through the neon light shielding layer prior to color correction through the near-infrared shielding layer.

The color correction layer 300 increases a color reproduction range of display, and a pigment having selective absorptivity may be used for the color correction layer to absorb unnecessarily emitted orange light of 580 nm to 600 nm, thereby improving definition of a screen.

Also, to shield near-infrared light, which is generated from the panel assembly and causes malfunctions of electronic apparatuses such as wireless telephones or remote controllers, a high polymer resin having a near-infrared shielding pigment that absorbs a wavelength of a near-infrared area may be used for the color correction layer 300. Since the PDP device emits strong near-infrared light over a wide wavelength area, it is necessary to use a near-infrared absorptive pigment that can absorb near-infrared light over the wide wavelength area.

For example, in the exemplary embodiment of the present invention, at least one pigment such as an anthraquinone based pigment, an aminium based pigment, a polymethyne based pigment, an azo based pigment, and an organic based pigment can be used for the color correction layer 130. The pigment used for the color correction layer 130 is not limited to the above pigments. The pigment is not limited to a specified value since the concentration and type of the pigment depend on absorptive wavelengths, absorptive coefficients, and transmittive characteristics required for display. When the organic based pigment is used, it is more advantageous than an inorganic based pigment for improving haze characteristics of the PDP filter.

Also, although not illustrated, according to another exemplary embodiment of the present invention, a transparent layer may further be provided to fill an empty portion of the electromagnetic shielding layer pattern 130. In this case, the color correction layer may be formed on the adhesive layer formed on the transparent layer.

A transparent adhesive may be used as the adhesive interposed between the respective layers or films. Examples of the adhesive include acrylic adhesive, silicon adhesive, urethane adhesive, PMB adhesive, ethylene-acetate acid vinyl based adhesive (EVA), polyvinylether, saturated amorphous polyester, and melamine resin.

Below, 125′ is used with “non-electroplating nuclear membrane” which is not described denotes a non-electroplating nuclear membrane and is a portion which is not blackened.

In the PDP filter according to the exemplary embodiment of the present invention, since the electromagnetic shielding layer including the non-electroplating layer pattern and the color correction layer including the organic based pigment are used, a haze value of less than 2.2% may be obtained, thus haze characteristics can be improved.

Hereinafter, a method for manufacturing the PDP filter illustrated in FIG. 2 will be described with reference to FIGS. 3 to 9. Process steps well-known to those skilled in the art of the present invention will be described briefly to avoid ambiguous misunderstanding of the present invention. Also, respective elements included in the PDP filter in the method for manufacturing the PDP filter will be substantially the same as those described above, and the same reference numerals will be used to refer to the same elements. Accordingly, repeated descriptions will be omitted or described briefly.

As illustrated in FIG. 3, a porous high polymer film 120 is formed on the transparent substrate 110.

A transparent hydrophilic material is used as the porous high polymer film 120, wherein examples of the transparent hydrophilic material include a vinylalcohol based resin, an acrylic based resin, and a cellulose based resin. The material of the porous high polymer film 120 is not limited to the above examples. The porous high polymer film 120 may be formed on one surface of the transparent substrate 110 by spin coating, roll coating, dipping, and bar coating. The porous high polymer film 120 has a thickness of 0.2 μm to 2 μm.

Next, as illustrated in FIG. 4, a non-electroplating nuclear membrane 125 is formed. The porous high polymer film may be the non-electroplating nuclear membrane 125 such that the non-electroplating nucleus is formed in the porous high polymer film 120, as illustrated in FIG. 3. The non-electroplating nuclear membrane 125 is not limited to such a porous high polymer film. For example, although not illustrated, the non-electroplating nuclear membrane may be layered on the surface of the porous high polymer film. In this case, the non-electroplating nucleus may be a chemical plating catalyst such as Pd or Ag.

At this time, the chemical plating catalyst serves as a catalyst that stimulates metal crystalline growth during a plating process. When Cu, Ni, or Au is plated, it is preferable to make a non-electroplating nucleus through a metal base process. Also, an Ag base solution, a Pd base solution, or a mixture of the two solutions may be used as a metal base solution. Since the non-electroplating nuclear membrane 125 formed of metal particles such as Pd or Ag has sufficient activity as a catalyst during the non-electroplating process to stimulate the metal crystalline growth through plating, a metal pattern having a greater compacted crystal can be obtained.

An example of a method for forming such a non-electroplating nuclear membrane 125 includes digesting the porous high polymer film in a chemical plating catalyst solution to allow the chemical plating catalyst to be permeated into the porous high polymer film or to be adsorbed into the surface of the porous high polymer film.

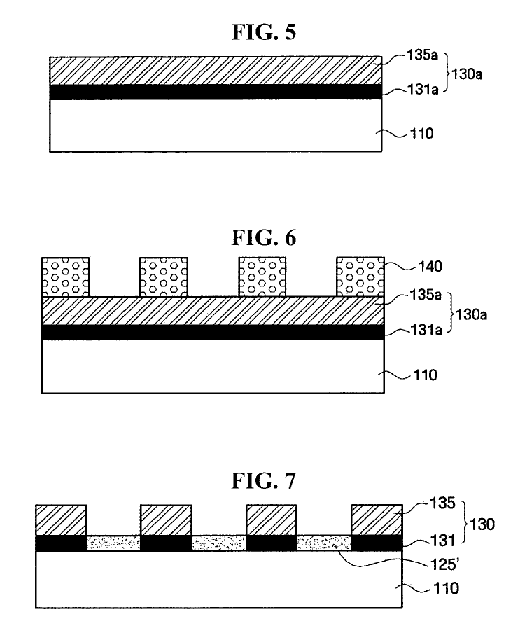

Next, as illustrated in FIG. 5, a non-electroplating layer 135a is formed on the non-electroplating nuclear membrane 125. At this time, the non-electroplating nuclear membrane 125 may be blackened by a metal component to form a blackened layer 131a. Accordingly, in the exemplary embodiment of the present invention, the blackened layer can be formed without any separate process. Obviously, the blackened layer may be formed by a separate process as necessary.

The non-electroplating layer 135a is a metal layer formed by the non-electroplating method, and a conductive material that can shield electromagnetic waves may be used as the non-electroplating layer 135a. For example, every metal having excellent electric conductivity and workability, such as Cu, Cr, Ni, Ag, Mo, W, and Al, may be used as the non-electroplating layer 135a. Among the above metals, Cu and Ni are preferable in view of cost, electric conductivity, and workability. More preferably, Cu may be used as non-electroplating layer 135a.

Next, as illustrated in FIG. 6, mask patterns 140 are formed on the non-electroplating layer 135a and then patterned to form an electromagnetic shielding pattern 130 as illustrated in FIG. 7, wherein the electromagnetic shielding pattern 130 includes the non-electroplating layer pattern 135 provided with a blackened layer pattern 131. At this time, the mask patterns 140 can be patterned by using nitric acid and FeCl₃. The non-electroplating layer exposed by the mask patterns 140 due to the patterning process of the mask patterns 140 is removed along with a blackened component of the blackened layer formed below the exposed non-electroplating layer, so that the non-electroplating nuclear membrane 125′ can partially be recovered. Accordingly, the blackened layer may be formed to remain only in a lower area of the non-electroplating layer pattern 135.

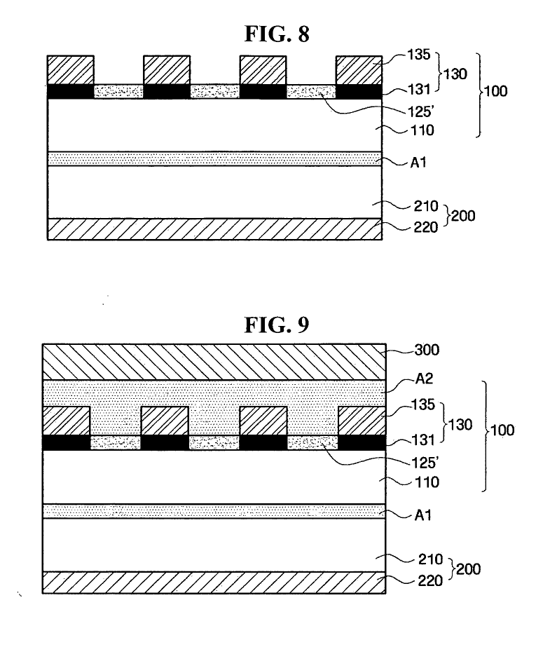

Subsequently, as illustrated in FIG. 8, the filter base 200 is adhered to one surface of the electromagnetic shielding layer 100. Specifically, the filter base 200 can be adhered to a surface of the transparent substrate 110 of the electromagnetic shielding layer 100, i.e., the surface of the transparent substrate 110 where the electromagnetic shielding pattern 130 is not formed.

The electromagnetic shielding layer 100 and the filter base 200 can be adhered to each other by an adhesive. The adhesive layer Al can be formed on one surface of the filter base 200 or the electromagnetic shielding layer 100.

At this time, the filter base 200 can be formed to have an optical function. A layer having an optical function, such as an antireflective layer 220, may, for example, additionally be formed on the transparent substrate 210. Also, although not illustrated, the filter base 200 may have another optical function in addition to an antireflective function.

In this case, the antireflective layer 220 of a single layer can easily be manufactured but has an antireflective function lower than that of a multilayered layer. The antireflective layer of a multilayered layer has an antireflective function over a wide wavelength area. When the antireflective layer 220 is formed of an inorganic compound thin film, the antireflective layer 220 can be formed by conventional, well-known methods such as sputtering, ion plating, ion beam assist, vacuum deposition, and wet coating. When the antireflective layer 220 is formed of an organic compound thin film, the antireflective layer 220 can be formed by conventional, well-known methods such as wet coating. The filter base 200 can be adhered to the electromagnetic shielding layer 100 in a state where the antireflective layer 220 is adhered to the transparent substrate 210. Alternatively, after the electromagnetic shielding layer 100 may be adhered to a surface of the transparent substrate 210 for the filter base, the antireflective layer 220 may be formed on another surface of the transparent substrate 210 for the filter base.

The antireflective layer 220 according to the exemplary embodiment of the present invention may be formed such that an oxide film of a low refractive index such as Sio₂ and an oxide film of a high refractive index such as TiO₂ and Nb₂O₅ are alternately stacked. The oxide films can be formed by sputtering or wet coating. The antireflective layer 220 has a thickness of 20 nm to 300 nm.

Next, as illustrated in FIG. 9, the color correction layer 300 is provisionally adhered onto the electromagnetic shielding layer 100. Specifically, the color correction layer 300 can provisionally be adhered onto the electromagnetic shielding layer 100 by using an adhesive layer A2. At this time, the color correction layer 300 may be a hybrid film having a neon light shielding function and a near-infrared shielding function, but a neon light shielding layer and a near-infrared shielding layer may separately be formed. Also, the adhesive layer A2 may be formed on one surface of either the electromagnetic shielding layer 100 or the color correction layer 300.

The color correction layer 300 can be manufactured on a PET substrate by wet coating of a neon light shielding pigment and/or a near-infrared shielding pigment.

Subsequently, an autoclave process is performed. Although not illustrated, the color correction layer 300 provisionally adhered onto the electromagnetic shielding layer 100 can completely be adhered to the electromagnetic shielding layer 100 by the autoclave process, whereby the electromagnetic shielding layer and the color correction layer can be fixed to each other. In the exemplary embodiment of the present invention, since the electromagnetic shielding layer and the color correction layer are adhered to each other in two steps such as the provisional adhesion process and the autoclave process, haze characteristics can be improved.

Specifically, in the exemplary embodiment of the present invention, the autoclave process can be performed at a temperature more than 30° C. and a pressure more than 4 Torr so as to optimize a haze value. When the temperature is less than 30° C., productivity is reduced. When the pressure is less than 4 Torr, the adhesive is not filled well between the non-electroplating layer patterns which causes fine bubbles, whereby the haze value may be reduced. Moreover, when considering economical efficiency, the autoclave process can be performed at a temperature between 30° C. and 60° C. and a pressure between 4 Torr and 7 Torr. At this time, the autoclave process can be performed for 30 minutes or greater.

In the present invention, when the respective layers or films are adhered to each other, a transparent adhesive can be used. Examples of the adhesive include acrylic adhesive, silicon adhesive, urethane adhesive, PMB adhesive, ethylene-acetate acid vinyl based adhesive (EVA), polyvinylether, saturated amorphous polyester, and melamine resin.

Since the PDP filter manufactured by the method according to the exemplary embodiment of the present invention has improved haze characteristics, a haze value less than 2.2% can be obtained.

As described above, in the method for manufacturing a PDP filter according to the exemplary embodiment of the present invention, the filter base 200 is adhered to the electromagnetic shielding layer 100 and then the color correction layer 300 is adhered thereto. However, the method is not limited to such operations. In other words, according to another exemplary embodiment of the present invention, after the electromagnetic shielding layer 100 and the color correction layer 300 are adhered to each other, the filter base 200 may be adhered to the electromagnetic shielding layer 100.

Hereinafter, physical properties of a sample of the PDP filter, which is manufactured in accordance with the exemplary embodiment of the present invention, will be described.

### EXPERIMENTAL EXAMPLE

A porous high polymer film was formed on one surface of a PET substrate at a thickness of 0.5 μm, and then was digested in a Pd colloid solution to form an non-electroplating nuclear membrane. Subsequently, a CU layer was formed on the non-electroplating nuclear membrane at a thickness of 3 μm by a non-electroplating method and then patterned. Subsequently, a surface of the PET substrate where the non-electroplating layer is not formed was adhered to one surface where black ceramic of reinforcing glass is formed. An adhesive was coated on an electromagnetic shielding layer, and a hybrid film including an aminium based organic dye was provisionally adhered to the electromagnetic shielding layer by an adhesive machine. Then, an antireflective layer was adhered to the other surface of reinforcing glass. An autoclave process was performed at a temperature of 50° C. and a pressure of 6.2 Torr for 30 minutes so that a PDP filter was completed. As a result of measuring the PDP filter using a hazemeter (manufacturer: GARDNER, model name: Haze-gard plus), a haze value of 1.8% was obtained.

### Comparable Experimental Example 1

In the same manner as the aforementioned experimental example, a PDP filter was manufactured. However, an autoclave process was performed at a temperature of 50° C. and a pressure of 3.0 Torr for 30 minutes, whereby a haze value of 20% was obtained.

### Comparable Experimental Example 2

A PDP filter was manufactured in the same manner as the aforementioned experimental example except for a use of a cobalt based dye. An autoclave process was performed at a temperature of 50° C. and a pressure of 6.2 Torr for 30 minutes, whereby a haze value of 3.1% was obtained.

In the PDP filter obtained in the aforementioned experimental example, haze characteristics of 1.8% were measured. In case of the comparable experimental example 1, the autoclave process was performed at a pressure less than that of the experimental example, whereby haze characteristics were remarkably deteriorated. Also, in case of the comparable experimental example 2, the cobalt based dye corresponding to an inorganic dye was used as a color correction layer, and it can be seen that haze characteristics were deteriorated in comparison with the experimental example that uses the organic dye.

As described above, according to the present invention, haze characteristics of the PDP filter can be improved.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A PDP filter comprising:
an electromagnetic shielding layer including an electromagnetic shielding pattern having a transparent substrate and an non-electroplating layer pattern formed on a surface of the transparent substrate;
a color correction layer formed on the electromagnetic shielding pattern; and
a filter base formed on another surface of the transparent substrate.

2. The PDP filter of claim 1, wherein a haze value is less than 2.2%.

3. The PDP filter of claim 1, wherein the color correction layer is a hybrid film that shields neon light and near-infrared light.

4. The PDP filter of claim 1, wherein the color correction layer is at least one selected from a group consisting of anthraquinone based pigment, aminium based pigment, polymethyne based pigment, and azo based pigment.

5. The PDP filter of claim 1, wherein the filter base includes the transparent substrate and an antireflective layer formed on one surface of the transparent substrate.

6. The PDP filter of claim 1, further comprising a blackened layer pattern formed on one surface of the electromagnetic shielding pattern adjacent to the transparent substrate.

7. A method for manufacturing a PDP filter, the method comprising:
forming a non-electroplating layer on one surface of a transparent substrate;
forming an electromagnetic shielding pattern by patterning the non-electroplating layer;
adhering a filter base onto another surface of the transparent substrate;
provisionally adhering a color correction layer onto the electromagnetic shielding pattern; and
fixing the color correction layer onto the electromagnetic shielding pattern by performing an autoclave process.

8. The method of claim 7, wherein the forming of the non-electroplating layer includes:
forming a non-electroplating nuclear membrane on the transparent substrate; and
forming the non-electroplating layer on the non-electroplating nuclear membrane.

9. The method of claim 8, wherein the forming of the non-electroplating nuclear membrane includes:
forming a porous high polymer film on the transparent substrate; and
digesting the porous high polymer film in a colloid solution for chemical plating.

10. The method of claim 9, wherein the colloid solution for chemical plating is a palladium (Pd) or a silver (Ag) colloid solution.

11. The method of claim 8, wherein the non-electroplating nuclear membrane is blackened when the non-electroplating layer is formed.

12. The method of claim 7, wherein the autoclave process is performed at a temperature more than 30° C. and a pressure more than 4 Torr.

13. The method of claim 12, wherein the autoclave process is performed at a temperature between 30° C. and 60° C., and at a pressure between 4 Torr and 7 Torr.

14. The method of claim 7, wherein a haze value of the PDP filter is less than 2.2%.

15. The method of claim 7, wherein the color correction layer is a hybrid film that shields neon light and near-infrared light.

16. The method of claim 7, wherein the color correction layer is at least one selected from a group consisting of anthraquinone based pigment, aminium based pigment, polymethyne based pigment, and azo based pigment.

17. The method of claim 7, wherein the filter base includes the transparent substrate and an antireflective layer formed on one surface of the transparent substrate.
